(19) United States
(12) Patent Application Publication
(10) Pub. No.: US 2009/0273151 A1
(43) Pub. Date: Nov. 5, 2009

(54) Toy chest and wagon

(76) Inventor: Mary Young, Redlands, CA (US)

Correspondence Address: RUTH EURE, 4795 EDISON AVENUE, BOULDER, CO, 80301, US

(21) Appl. No.: 12/383,051

(22) Filed: Mar. 18, 2009

Related U.S. Application Data
(60) Provisional application No. 61/069,768, filed on Mar. 18, 2008.

(51) Int. Cl. B62B 3/02

(52) U.S. Cl. 280/47.34

(57) ABSTRACT

A toy chest which has wheels and a removable handle for conversion of the toy chest into a wagon is provided. Also is provided a toy chest and wagon which has wheels that can be concealed by use of a panel.

### CLAIM OF PRIORITY

The present application claims priority from U.S. Provisional Patent Application Ser. No. 61/069,768, filed Mar. 18, 2008, of common title and inventorship herewith.

### FIELD OF THE INVENTION

The present invention pertains to the field of convertible and portable furniture, and more specifically to the field of toy chests which are equipped with wheels and are convertible to wagons.

### BACKGROUND OF THE INVENTION

The prior art has put forth several disclosures of convertible toy chests. Among these are:

U.S. Pat. No. 1,527,793 to Froelich describes a combination toy chest, cradle and bed.

U.S. Pat. Des. 365,701 describes a toy chest on wheels.

U.S. Pat. Des. 190,999 to Mykleby describes another design of a toy chest on wheels.

None of these prior art disclosures describe or suggest the toy chest and wagon of the present invention.

### SUMMARY OF THE INVENTION

It is an object of the present invention to provide a toy chest which has wheels and a removable handle for conversion of the toy chest into a wagon.

It is a further object of the present invention to provide a toy chest which has wheels that can be concealed by use of a panel.

### BRIEF DESCRIPTION OF THE DRAWINGS

FIG. 1 is a perspective view of the present invention in the form of a wagon.

FIG. 2 is a perspective view of the present invention in the form of a toy chest with the panel covering the wheels.

FIG. 3 is a perspective view of the present invention in the form of a toy chest.

FIG. 4 is a close-up showing the removable handle for the wagon.

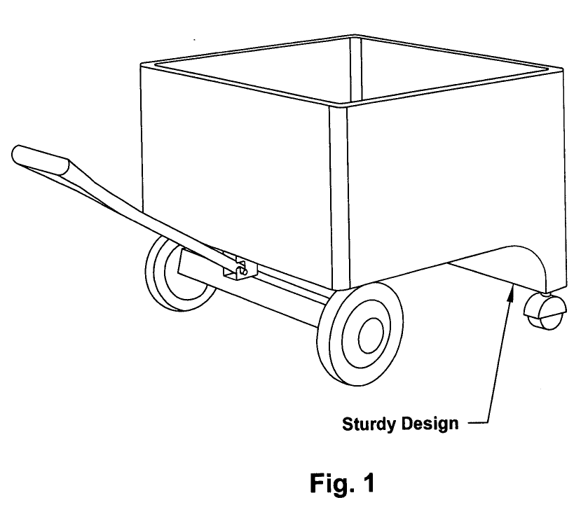

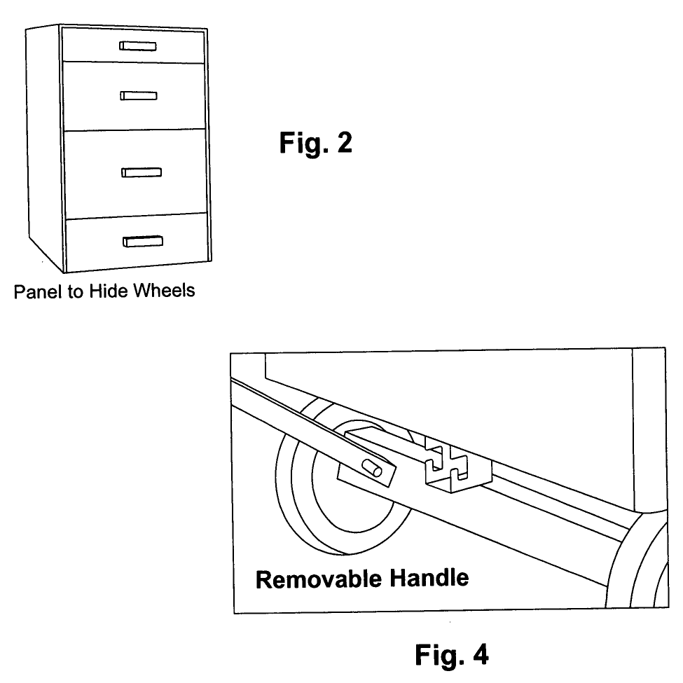

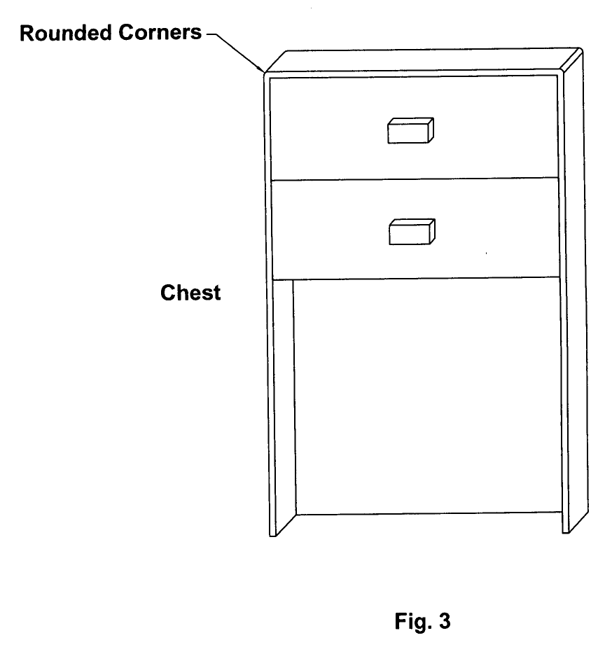

### DETAILED DESCRIPTION OF THE INVENTION

Toys and games have been around as long as children have been around. While the materials and technology may have changed over the years, the toys of today are very much like those with which ancient children played: dolls, hoops, handmade animals, little weapons, vehicles, and boats have been favored items of play for many generations. In the modern era, sales of classic traditional toys such as Hot Wheels', Barbie', Mr. Potato Head', and even yo-yos continue to flourish, despite the foreboding in recent years that these would suffer in popularity from the onslaught of computer, video, and handheld forms of play. While toy fads come and go, some toys remain timeless classics. Simplistic in design and appealing to a wide age range, traditional-type toys are the ones that children play with over and over, long after this season's hot new item is consigned to the bottom of the toy chest.

Whether dolls, stuffed animals, Lincoln Logs, or building blocks, it is not uncommon to see the floors of children's play rooms virtually covered with a plethora of different toys. Parents and caregivers are constantly picking up behind rambunctious young ones, trying in vain to keep toys neatly stored in a toy chest or closet. While they may endeavor to teach their kids to keep their playrooms neat and tidy, parents know that these attempts are futile; after all, children are children, and having the maximum amount of fun that they can is essentially their main concern.

Recognizing the potential for a unique product that could encourage children to keep a neater playroom while having fun doing so, the present invention was developed, and is hereinafter referred to as the Toy Chest and Wagon. As the name implies, the Toy Chest and Wagon is just that, a wheeled wagon and multi-drawered toy chest, cleverly combined into one convenient unit. This product can be fashioned from a durable material such as oak wood material, for example, measuring approximately forty-two inches (42″) in length, thirty-six inches (36″) in width, and thirty-six inches (36″) in depth.

Like standard wagons, the bottom can be outfitted with four, six-inch (6″) hard rubber wheels connected via framework to a ball-bearing type axle. In an alternative embodiment, there may be two larger wheels at the front of the wagon, and two smaller wheels at the rear of the wagon.

This axle features a durable connection pin that secures an elongated tubular removable handle, which serves to control the wagon. This handle is removable, as can be seen in FIG. 4.

Unique to the Toy Chest & Wagon and what sets it apart from common wagons is found in its storage capabilities. Vertically extending from the back end of the wagon is a two-drawer unit, each with an approximate depth of thirteen and one half inches (13½″). Below these drawers, the remaining open portion of the wagon provides additional storage space or be able to accommodate a small child for riding.

As an additional consideration, the Toy Chest & Wagon can be made available in a wide variety of fun and whimsical colors. Use and application of the Toy Chest & Wagon is very simple and straightforward. For basic play, the unit can be appropriated as a standard wagon, with a child pulling the handle to move the unit around the house or out in the yard. Yet importantly, the Toy Chest and Wagon would be used to create a “clean up” game with the child. A parent or caregiver could show the child how much fun it is to wheel the unit around the playroom or home, picking up scattered toys, and hiding them away in the drawers of the chest. As a result, loose playthings are quickly gathered and put away, in such a neat and exciting manner.

There are several significant benefits and advantages associated with this delightful and unique product invention. Foremost, the Toy Chest and Wagon provides a means of neat toy storage as well as a fun way of accomplishing such, in one convenient unit. Combining the classic wagon with a multi-drawered toy chest, this product offers parents a clever new way to encourage young ones to clean up after themselves after play time. In this manner, adults can alleviate the constant picking up of toys, freeing much needed time for themselves. In addition to offering handy and neat toy storage, the Toy Chest and Wagon also provides children with a delightful new toy that inspires hours of merriment. In addition, this high-energy toy inspires rambunctious youngsters to channel their restlessness, aggression, and never-ending desire for fun into a positive activity. Fun-loving adults will also appreciate the benefits afforded by the Toy Chest and Wagon, as they can participate in positive parent-child interaction with their kids or simply employ the device to relieve tension after a particularly stressful day. Made of durable, high quality materials, this product will withstand years of continued use. Moreover, the Toy Chest and Wagon's simple, universal design lends this toy a classic appeal, ensuring that it can be enjoyed for many generations to come.

The Toy Chest and Wagon is an innovative invention that will fill a child's play time with excitement and energy. Moreover, the creative combination of a toy chest with a wagon is a handy tool in teaching children the importance of keeping their play areas clean and uncluttered.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A toy chest and wagon comprising:
a chest portion having a multiplicity of drawers;
2 large wheels;
2 smaller wheels;
a removable handle; and
a removable panel.

2. The toy chest and wagon of claim 1 wherein the large wheels are approximately 6 inches in diameter.

3. The toy chest and wagon of claim 1 which is made of wood.

4. The toy chest and wagon of claim 1 wherein the dimensions are approximately forty-two inches (42″) in length, thirty-six inches (36″) in width, and thirty-six inches (36″) in depth; and further having 2 wheels approximately 6″ in diameter at the front of the wagon and two smaller wheels at the rear of the wagon; and further a removable panel for concealing the wheels.
